(19) United States
(12) Patent Application Publication
(10) Pub. No.: US 2008/0281508 A1
(43) Pub. Date: Nov. 13, 2008

(54) Vehicle navigation system and method thereof

(75) Inventor: Wen-Chih Fu, Taipei (TW)

Correspondence Address: BACON & THOMAS, PLLC, 625 SLATERS LANE, FOURTH FLOOR, ALEXANDRIA, VA, 22314-1176, US

(73) Assignee: E-TEN INFORMATION SYSTEMS CO., LTD., Taipei (TW)

(21) Appl. No.: 11/889,499

(22) Filed: Aug. 14, 2007

(30) Foreign Application Priority Data
May 8, 2007 (TW) 096116341

(51) Int. Cl. G01C 21/34; G06F 17/30

(52) U.S. Cl. 701/201; 707/3

(57) ABSTRACT

A vehicle navigation system comprises a signal receiving module, a location selection module, a route planning module, an image obtaining module, a display module and a route selection module. The signal receiving module is used for obtaining first location information of a vehicle; the location selection module is used for obtaining second location information of the vehicle; the route planning module is used for obtaining a suggested route for the vehicle according to the first location information and second location information; the image obtaining module is used for obtaining at least one image related to the suggested route; the display module is used for displaying the at least one image; and the route selection module is used for selecting whether to keep the original suggested route or to activate the route planning module to obtain a new suggested route.

### BACKGROUND OF THE INVENTION

1. Field of the Invention

The present invention relates to a vehicle navigation system, and, more particularly, to a vehicle navigation system and related method which is capable of displaying images related to a suggested route for the vehicle.

2. Description of the Related Art

Generally, while driving, a driver would like to be informed of the road conditions ahead (such as the traffic condition, whether there are any accidents or road construction, etc.) to avoid traffic jams, and so he or she may save on driving time and have a safer trip.

However, prior art vehicle navigation systems can usually provide only navigation suggestions based on predetermined routes, and are unable to provide to the driver road conditions along the predetermined routes. Therefore, the driver may drive onto a road that has poor traffic conditions. Although some radio programs provide wide area traffic conditions, they generally do not provide the traffic conditions along the particular route. Furthermore, road condition opinions can be personal, and therefore the road conditions provided by the radio program may not be sufficiently precisely for the driver. Plus, road conditions provided by the radio program are not updated in real-time, and may thus mislead the driver.

Therefore, it is desirable to provide a vehicle navigation system and related method to mitigate and/or obviate the aforementioned problems.

### SUMMARY OF THE INVENTION

A main objective of the present invention is to provide a vehicle navigation system capable of showing images related to a suggested route for the vehicle.

The vehicle navigation system of the present invention comprises a signal receiving module, a location selection module, a route planning module, an image obtaining module, a display module and a route selection module. The signal receiving module is used for obtaining first location information of a vehicle; the location selection module is used for obtaining second location information of the vehicle; the route planning module is used for obtaining a suggested route for the vehicle according to the first location information and second location information; the image obtaining module is used for obtaining at least one image related to the suggested route; the display module is used for displaying the at least one image; and the route selection module is used for selecting whether to keep the original suggested route or to activate the route planning module to obtain a new suggested route.

The vehicle navigation method of the present invention comprises the steps of:
obtaining first location information of a vehicle;
obtaining second location information of the vehicle;
according to the first location information and the second location information, obtaining a suggested route for the vehicle;
according to the suggested route, obtaining at least one image related to the suggested route; and
displaying the at least one image related to the suggested route for a subsequent decision of whether to keep the suggested route.

In one embodiment of the present invention, the first location information is current location information of the vehicle; and the second location information is destination location information of the vehicle. In one embodiment of the present invention, the first location information is obtained by utilizing a global position system (GPS) or an assisted global position system (AGPS). In the present invention, the image related to the suggested route is obtained from at least one webcam by connecting to an Internet address of the at least one webcam through an Internet, a general packet radio service (GPRS), a third generation (3G) mobile communication system, a wireless fidelity (Wi-Fi) system or a worldwide interoperability for microwave access (WiMAX) network.

Other objects, advantages, and novel features of the invention will become more apparent from the following detailed description when taken in conjunction with the accompanying drawings.

### BRIEF DESCRIPTION OF THE DRAWINGS

FIG. 1 is a structural drawing of a vehicle navigation system according to the present invention.

FIG. 2A illustrates a vehicle navigation system obtaining an image related to a suggested route according to the present invention.

FIG. 2B is another illustration of a vehicle navigation system obtaining an image related to a suggested route.

FIG. 3 is a flowchart of a vehicle navigation method according to the present invention.

FIGS. 4A to 4D show an image related to a suggested route obtained by a vehicle navigation system according to the present invention.

### DETAILED DESCRIPTION OF THE PREFERRED EMBODIMENT

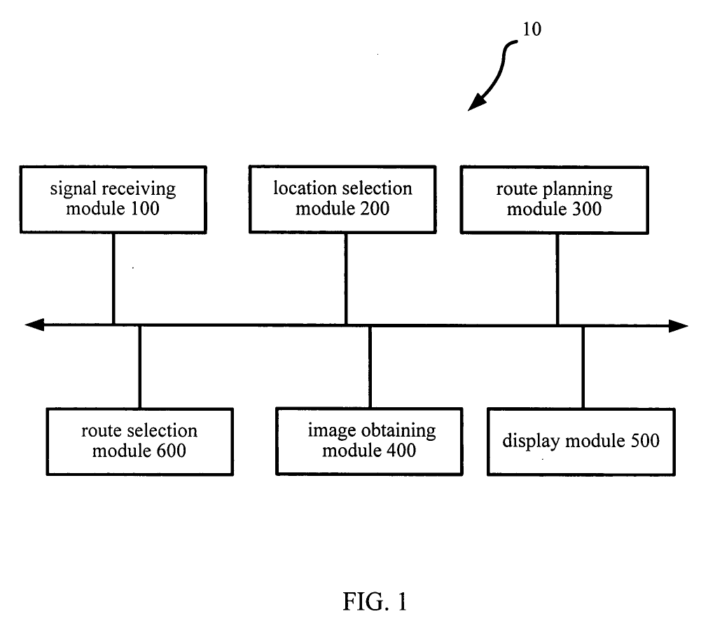

Please refer to FIG. 1. FIG. 1 is a structural drawing of a vehicle navigation system according to the present invention. As shown in FIG. 1, a vehicle navigation system 10 comprises a signal receiving module 100, a location selection module 200, a route planning module 300, an image obtaining module 400, a display module 500 and a route selection module 600. In an embodiment, the above-mentioned modules can be electrically connected to each other via a physical connection or a wireless connection. Furthermore, the above-mentioned modules can be carried out as a hardware device, a software program, a circuit or any other equivalent design; and each module can exist as a single module or be combined into an integrated module. Moreover, in one embodiment of the present invention, the vehicle navigation system 10 is a personal digital assistant (PDA).

With the vehicle navigation system 10 of the present invention, when a user (such as a driver) wants to obtain vehicle navigation information, the signal receiving module 100 is used for obtaining first location information of the vehicle (such as current location information for the vehicle), and the location selection module 200 is used for obtaining second location information of the vehicle (such as destination location information for the vehicle). In one embodiment of the present invention, the first location information is longitude and latitude coordination information. The signal receiving module 100 comprises a receiving antenna and a corresponding signal processing circuit and is used for receiving wireless signals form the global positioning system (GPS), the Galileo positioning system or an assisted global positioning system (AGPS) to obtain longitude and latitude coordination information. However, the signal receiving module 100 can also receives other signals that provide location information. Furthermore, while the vehicle is moving, the signal receiving module 100 can dynamically receive and update the first location information with new vehicle locations. In one embodiment of the present invention, the second location information is longitude and latitude coordination information, and the location selection module 200 can provide an input interface for accepting a second location (such as a destination location name for the vehicle) as provided in prior art navigation software, and then extracts the corresponding longitude and attitude coordination information of the second location from a database (not shown) to obtain the second location information.

After obtaining the first location information and the second location information of the vehicle, the route planning module 300 selects and arranges a route according to the first location information and the second location information to establish a suggested route for the vehicle, which is a predetermined route for the vehicle to travel along from the first location to the second location. In one embodiment of the present invention, the route planning module 300 is carried out by software, and the related technologies of receiving GPS or AGPS signals and how to select and arrange the route are all well-known in this field, and so need no further description.

After obtaining the suggested route for the vehicle, the vehicle navigation system 10 obtains at least one image related to the suggested route via the image obtaining module 400. In one embodiment of the present invention, the image obtaining module 400 includes prior art software and hardware for a network connection, and the at least one image related to the suggested route is an image recorded by one or more webcams positioned along the suggested route. The image obtaining module 400 can also obtain other images related to the suggested route. In addition, since road conditions such as traffic jams, road construction or traffic accidents are not short term incidents, in one embodiment of the present invention, the image obtaining module 400 can obtain “real-time” or “synchronous” images related to the suggested route, or “non real-time” or “asynchronous” images related to the suggested route, but which are updated regularly. The images related to the suggested route obtained by the image obtaining module 400 may be static images or dynamic images.

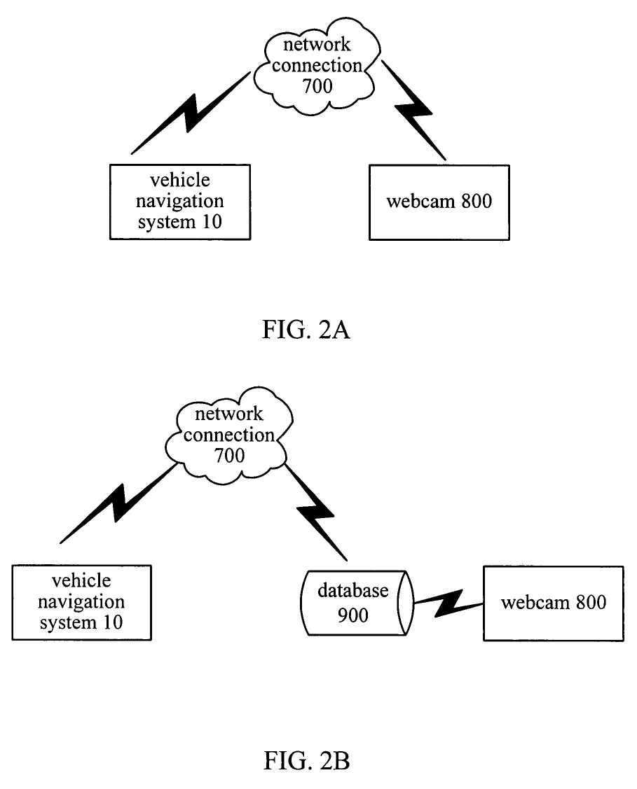

Please refer to FIGS. 2A and 2B. FIG. 2A is an illustration of a vehicle navigation system obtaining an image related to the suggested route according to the present invention. FIG. 2B is another illustration of the vehicle navigation system obtaining an image related to the suggested route. As shown in FIG. 2A, in one embodiment of the present invention, the vehicle navigation system 10 is connected to every webcam 800 (only one of them is shown in the drawing) located along the suggested route by way of a network connection 700, such as the Internet, to obtain an image related to the suggested route from each webcam 800. In one embodiment of the present invention, to ensure the vehicle navigation system can successfully connect to the Internet address of each webcam 800 located along the suggested route, the Internet addresses (IP address) and their related location information are stored in a database (not shown) included in the image obtaining module 400. In one embodiment of the present invention, the Internet address can be other types of connection information which can be recognized by the vehicle navigation system.

Therefore, based on a current location, control software in the image obtaining module 400 sequentially obtains and connects to the Internet address of each webcam 800 located along the suggested route, from the closer webcam 800 to the farther webcam 800. Alternatively, a remote server (not shown) can be used for storing the data to replace the database.

On the other hand, as shown in FIG. 2B, in one embodiment of the present invention, the image obtaining module 400 connects to a database 900 in a remote server (not shown) via the Internet 700 to obtain the image related to the suggested route recorded by each webcam 800 and stored in the database 900. The image related to the suggested route recorded by each webcam 800 and stored in the database 900 of the remote server can be updated by new images recorded by each webcam 800, and the images stored in the database 900 may be arranged corresponding to the locational arrangement of the webcam 800; therefore, the image obtaining module 400 can identify each webcam 800 location in the database 900, from the closest to the farthest, along the suggested route and then extract the image recorded by each webcam 800.

The image related to the suggested route recorded by each webcam 800 can be pre-stored in the database 900 by wired connections, wireless connection or via a server; however, this technology is beyond the scope of the present invention, and so there is no need for further description. In one embodiment of the present invention, the image obtaining module 400 can connect to the Internet address of each webcam 800 or the database 900 via a network connection, such as a general packet radio service (GPRS), a third generation (3G) mobile communication, a wireless fidelity (Wi-Fi) connection, or a worldwide interoperability for microwave access (WiMAX) network to obtain the image related to the suggested route recorded by each webcam 800. However, the present invention may also utilize other technologies to obtain the image related to the suggested route recorded by each webcam 800.

Next, the display module 500 displays the at least one image related to the suggested route. The user can decide whether to keep the original suggested route or to cause the route selection module 600 to enable the route planning module 300 to obtain a new suggested route according to the road conditions on the suggested route shown by the images. In one embodiment of the present invention, the display module 500 comprises a liquid crystal screen, and the route selection module 600 comprises a button or an operating interface for the user to select whether to enable the route planning module 300 to obtain a new suggested route.

In one embodiment of the present invention, under the control of the control software of the image obtaining module 400, the display module 500 can selectively display images related to the suggested route from a plurality of webcams 800 closest to the first location (which is the current location of the vehicle). For example, the display module 500 can display images related to the suggested route from a predetermined amount of webcams 800 (such as 3 to 5) closest to the current location of the vehicle, and also continuously display images related to the suggested route from the farthest webcams 800 so the user can be made aware of the coming road conditions for the vehicle. Therefore, the user can decide whether to continue along the original suggested route or to cause the route planning module 300 to obtain a new suggested route according to the road conditions on the suggested route shown on the images from the webcam 800.

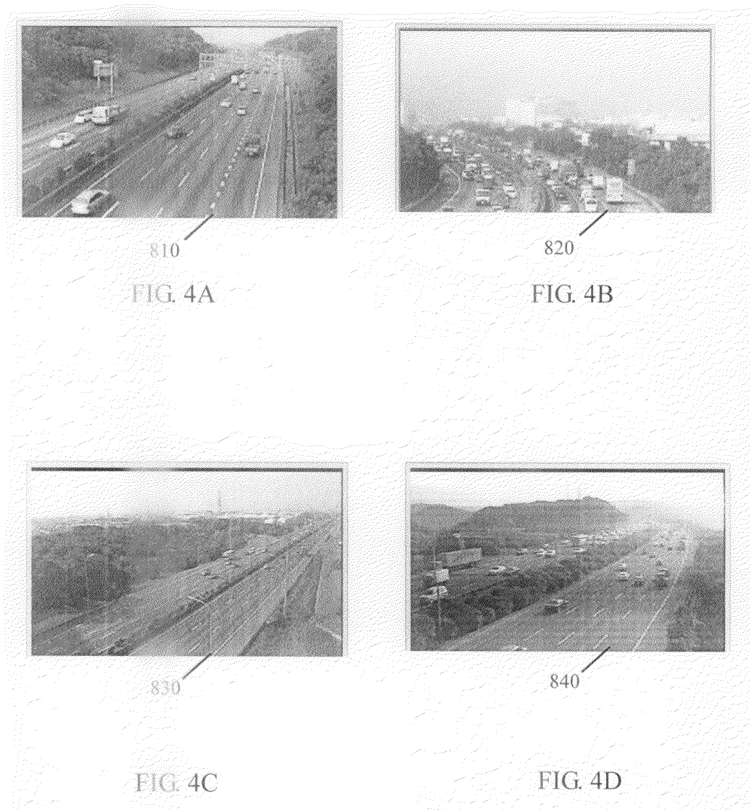

As shown in FIG. 4A to FIG. 4D, the display module 500 displays images related to the suggested route 810, 820, 830 and 840 from 4 webcams 800 closest to the current location of the vehicle so that the user is aware of the coming road conditions for the vehicle. In FIG. 4A to FIG. 4D, the images related to the suggested route 810, 830 and 840 all display good road conditions, but the image information 820 shows a traffic jam; therefore, the user may determine whether to continue along the original suggested route or to cause the route planning module 300 to obtain a new suggested route to avoid the traffic jam shown in the image information 820.

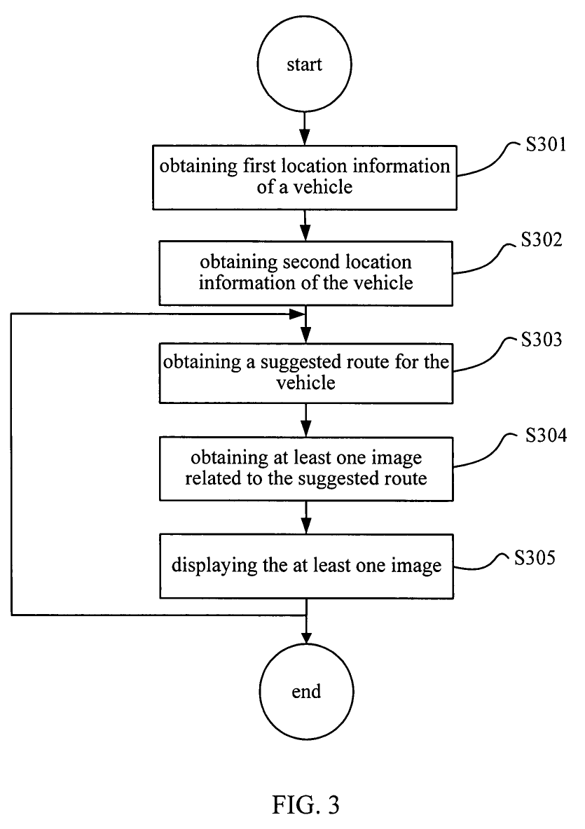

Next, please refer to FIG. 3. FIG. 3 shows a flowchart of a vehicle navigation method according to the present invention. In one embodiment of the present invention, the vehicle navigation method of the present invention can be performed with the vehicle navigation system of the present invention or any other equivalent system or device. As shown in FIG. 3, in one embodiment of the present invention, the vehicle navigation method comprises steps S301, S302, S303, S304 and S305.

When vehicle navigation is needed, step S301 is first performed to obtain the first location information of the vehicle. In step S301, the present invention utilizes a global positioning system (GPS) or an assisted global positioning system (AGPS) to obtain the first location information of the vehicle. In one embodiment of the present invention, the first location information is the current location information or a predetermined departure location of the vehicle. Furthermore, while the vehicle is moving, the present invention can be repeated at predetermined time periods to dynamically receive and update the first location information according to the new vehicle location.

While step S301 is performed, the present invention can simultaneously or continuously perform step S302 to obtain the second location information for the vehicle. In step S302, the present invention extracts the corresponding longitude and latitude coordinate information of the second location from a database to obtain the second location information. In one embodiment of the present invention, the second location information can be obtained from destination location information for the vehicle or mid-point location information.

After obtaining the first location information and the second location information for the vehicle, step S303 is performed to obtain the suggested route for the vehicle, which is a predetermined route for the vehicle from the first location to the second location according to the first location information and the second location information.

Next, step S304 is performed, to obtain at least one image related to the suggested route. In one embodiment of the present invention, in step S304, the image related to the suggested route is taken by each webcam located along the suggested route and is obtained. Furthermore, in one embodiment, the present invention can obtain “real-time” or “synchronous” images related to the suggested route or “non real-time” or “asynchronous” images related to the suggested route but which are updated regularly. In one embodiment of the present invention, the present invention establishes a connection with the Internet address of each webcam located along the suggested route to obtain the images related to the suggested route from each webcam. In one embodiment of the present invention, the present invention connects to a database via a network to obtain the image related to the suggested route recorded by each webcam and stored in the database. In one embodiment of the present invention, the present invention can connect through a network connection, such as a general packet radio service (GPRS), a third generation (3G) mobile communication system, a wireless fidelity (Wi-Fi) system, or a worldwide interoperability for microwave access (WiMAX) network, to obtain the image related to the suggested route recorded by each webcam. However, the present invention may also utilize other technologies to obtain the images related to the suggested route recorded by each webcam.

After obtaining the image related to the suggested route recorded by each webcam, step S305 is performed to display each image related to the suggested route. The user can decide whether to keep the original suggested route or to plot a new suggested route according to the road conditions on the suggested route indicated by the images. In step S305, the present invention can present various selected images related to the suggested route. For example, images related to the suggestion route from the 3 to 5 webcams closest to the current location of the vehicle may be displayed, as well as continuous images related to the suggested route from farther webcams so that the user is aware of the coming road conditions for the vehicle.

Therefore, the user can decide whether to keep the original suggested route or to obtain a new suggested route by performing step S303 again according to the road conditions on the suggested route shown on the images from the webcams.

Next, the present invention performs step S304 to obtain at least one new image related to the new suggested route according to the new suggested route. Then, the present invention performs step S305 to display the at least one new image related to the new suggested route so the user can decide whether to keep the new suggested route or to make another new suggested route according to the road conditions on the suggested route shown by the images. If it's necessary, the present invention can keep repeating steps S303, S304 and S305 until the user decides not to obtain a new suggested route for the vehicle.

With the vehicle navigation system and the vehicle navigation method of the present invention, the user can view road condition images to avoid traffic delays, which may improve vehicle navigation and trip quality.

Although the present invention has been explained in relation to its preferred embodiment, it is to be understood that many other possible modifications and variations can be made without departing from the spirit and scope of the invention as hereinafter claimed.

What is claimed is:

1. A vehicle navigation system comprising:
a signal receiving module, for obtaining first location information of a vehicle;
a location selection module, for obtaining second location information of the vehicle;
a route planning module electrically connected to the signal receiving module and the location selection module, for obtaining a suggested route for the vehicle according to the first location information and the second location information;
an image obtaining module electrically connected to the route planning module, for obtaining at least one image related to the suggested route according to the suggested route; and
a display module electrically connected to the image obtaining module, for displaying the at least one image related to the suggested route.

2. The vehicle navigation system as claimed in claim 1 further comprising a selection module, for selecting whether to keep the suggested route or to enable the route planning module to obtain a new suggested route according to the at least one image related to the suggested route.

3. The vehicle navigation system as claimed in claim 1, wherein the first location information is current location information of the vehicle and the second location information is destination location information of the vehicle.

4. The vehicle navigation system as claimed in claim 1, wherein the at least one image related to the suggested route obtained by the image obtaining module is obtained from at least one webcam related to the suggested route.

5. The vehicle navigation system as claimed in claim 1, wherein the at least one image related to the suggested route obtained by the image obtaining module is a real-time image related to the suggested route.

6. The vehicle navigation system as claimed in claim 4, wherein the image obtaining module is adapted to connect to the at least one webcam and obtain the at least one image related to the suggested route from the at least one webcam by obtaining an Internet address (IP Address) of the at least one webcam.

7. The vehicle navigation system as claimed in claim 4, wherein the image obtaining module is adapted to connect to a database through a network connection to obtain the at least one image related to the suggested route from the at least one webcam stored in the database.

8. The vehicle navigation system as claimed in claim 4, wherein the display module displays the at least one image related to the suggested route from the closer webcam to the farther webcam as determined from the first location.

9. The vehicle navigation system as claimed in claim 8, wherein the display module displays the at least one image related to the suggested route from a predetermined number of the closest webcams located away from the first location.

10. A vehicle navigation method comprising:
obtaining first location information of a vehicle;
obtaining second location information of the vehicle;
according to the first location information and the second location information, obtaining a suggested route of the vehicle;
according to the suggested route, obtaining at least one image related to the suggested route; and
displaying the at least one image related to the suggested route for a subsequent decision of whether to keep the suggested route.

11. The vehicle navigation method as claimed in claim 10 further comprising:
in response to the subsequent decision, obtaining a new suggested route;
according to the new suggested route, obtaining at least one new image related to the new suggested route; and
displaying the at least one new image related to the suggested route for a further subsequent decision of whether to keep the new suggested route.

12. The vehicle navigation method as claimed in claim 10, wherein the first location information is current location information of the vehicle and the second location information is destination location information of the vehicle.

13. The vehicle navigation method as claimed in claim 10, wherein the at least one image related to the suggested route is obtained from at least one webcam related to the suggested route.

14. The vehicle navigation method as claimed in claim 10, wherein the at least one image related to the suggested route is a real-time image related to the suggested route obtained from at least one webcam related to the suggested route.

15. The vehicle navigation method as claimed in claim 13, wherein the at least one image related to the suggested route from the at least one webcam is obtained by accessing to an Internet address (IP Address) of the at least one webcam.

16. The vehicle navigation method as claimed in claim 13, wherein the at least one image related to the suggested route from the at least one webcam is obtained by reading the at least one image related to the suggested route from at least one webcam stored in a database.

17. The vehicle navigation method as claimed in claim 13, wherein the displayed at least one image related to the suggested route is obtained from the closer webcam to the farther webcam as determined from the first location.

18. The vehicle navigation method as claimed in claim 17, wherein the at least one image related to the suggested route is displayed from a predetermined number of the closest webcams located away from the first location.

19. A method of obtaining an image related to a suggested route for a vehicle comprising:
providing a database storing connection information and location information of a plurality of video cameras, each video camera used for recording at least one image related to a suggested route at a location corresponding to that video camera;
according to the suggested route of the vehicle, extracting from the database the connection information of the video camera of at least one location on the suggested route;
connecting to the at least one video camera based on the connection information; and
obtaining the recorded image related to the suggested route from the video camera.

20. A method of obtaining an image related to a suggested route for a vehicle comprising:
connecting to a database storing connection information and location information of a plurality of video cameras;
according to a suggested route for the vehicle, identifying the video camera of at least one location on the suggested route from the database; and
extracting an image related to the suggested route recorded by the at least one video camera.

21. A method of obtaining an image related to a suggested route for a vehicle comprising:
according to a suggested route of the vehicle, obtaining a plurality of images related to the suggested route from a plurality of video cameras on the suggested route; and
according to distances from a current location, displaying the image related to the suggested route from at least one video camera.

22. The method as claimed in claim 21, wherein a predetermined number of images related to the suggested route are obtained from the closer webcam to the farther webcam as determined from the first location.
